(19) United States
(12) Patent Application Publication
(10) Pub. No.: US 2010/0155336 A1
(43) Pub. Date: Jun. 24, 2010

(54) PIPELINE FILTER

(76) Inventor: Roger M. Simonson, Calgary (CA)

Correspondence Address: BENNETT JONES LLP;C/O MS ROSEANN CALDWELL, 4500 BANKERS HALL EAST, 855 - 2ND STREET, SW, CALGARY, AB, T2P 4K7, CA

(21) Appl. No.: 12/546,374

(22) Filed: Aug. 24, 2009

Related U.S. Application Data
(63) Continuation-in-part of application No. PCT/CA2008/000346, filed on Feb. 22, 2008.
(60) Provisional application No. 60/891,131, filed on Feb. 22, 2007.
(60) Provisional application No. 61/117,393, filed on Nov. 24, 2008.

(51) Int. Cl. B01D 35/02; B03C 1/02; B01D 35/06

(52) U.S. Cl. 210/695; 210/222

(57) ABSTRACT

A pipeline filter includes: a pipeline mounting structure for mounting the pipeline filter in a pipeline, a screen support connected to the mounting structure and formed for releasably securing a screen filter to the pipeline filter and a magnetic filter support through which a magnetic filtering device is securable to the mounting structure.

### FIELD

The present invention relates to filters and, in particular, pipeline filters.

### BACKGROUND

In the oil, gas, refinery and chemical process industries pipeline filters, also known as cone strainers, are installed in the piping before pumps and compressors. They include screen-type filtering means that are designed to remove oversize foreign materials and welding slag left inside the piping from fabrication before such materials enter the pumps, compressors and flow meters.

These pipeline filters allow the pipeline fluid to flow from the one side of the screen to the other, with any debris that is unable to pass through the screen being caught up on the screen material. Some pipeline filters have their screen formed conically.

Pipeline filters are often placed in service on a temporary basis such as for one or two weeks. Thereafter, since they may resist the flow of fluid though the pipeline, the filters are removed to allow maximum flow of the gas or fluid. Once removed the pipeline system operates with no protection from debris and ferrous metal contamination.

The ferrous metal contamination may be from contamination or the result of erosion and corrosion of the piping and storage facilities, which are primarily made from carbon steel. Contamination of pipeline fluids by ferrous metal can cause wear to the flow meters, pump seals and compressors and the removal of pipeline filters, in spite of their resistance to pipeline flow, can reduce the useful life of pipeline apparatus.

### SUMMARY

In accordance with one broad aspect of the present invention, there is provided a pipeline filter comprising: a pipeline mounting structure for mounting the pipeline filter in a pipeline, a screen support connected to the mounting structure and formed for releasably securing a screen filter to the pipeline filter and a magnetic filter support through which a magnetic filtering device is securable to the mounting structure.

In accordance with another broad aspect of the present invention, there is provided a pipeline filter comprising: a pipeline mounting structure for mounting the pipeline filter in a pipeline; a screen support connected to the mounting structure; a screen filter releasably secured to the screen support; a magnetic filter support; and a magnetic filtering device secured to the mounting structure.

In accordance with another broad aspect of the present invention, there is provided a method for filtering fluids flowing in a pipeline comprising: installing in the pipeline a pipeline filter including a magnetic filtering device and a screen filtering device secured to the magnetic filtering device; and allowing the fluids to pass through a magnetic field generated by the magnetic filtering device and thereafter allowing the fluids to pass through the screen filtering device.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1 is an end view of one embodiment of a pipeline filter. The view is shown without a magnetic filtering device installed therein to facilitate illustration of the magnetic filtering device installation structure;

FIG. 2 is an isometric view of the filter of FIG. 1 with a portion shown in section taken along line I-I of FIG. 1 and a magnetic filtering device installed therein;

FIG. 3 is a side elevation of a pipeline with a pipeline filter installed therein;

FIG. 4 is an isometric view of another pipeline filter with all filtering devices removed;

FIG. 5 is a sectional view taken through the filter of FIG. 4 along a line positioned similarly to line I-I of FIG. 1 and installed in a pipe;

FIG. 6 is a side elevation of a magnetic filter assembly useful in a pipeline filter according such as that shown in FIG. 4; and

FIG. 7 is an isometric view of another pipeline filter with a section along a line similar to that of FIG. 2.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

A pipeline filter according to the present invention operates as a multi stage magnetic cone strainer. The pipeline filter is an apparatus that utilizes present technology of screen materials in an advanced format and with magnetic filtration technology. This design will provide filtration by size exclusion and/or by magnetic attraction of damaging ferrous contamination. Such magnetic filtration may be provided on an ongoing basis, thereby providing for increased longevity of the pipeline, the pumps and/or compressors and/or cleaner fluids for the refining and end users of the pipeline products.

The present pipeline filter includes a support structure for retaining a magnetic filter designed to extract and trap ferrous contamination down to and below 1 micron in size without causing flow restriction concerns for the fluid or gas. It has also been determined that the magnetic filter may reduce static electricity in a pipeline. As such, the present pipeline filter may be useful for applications in pipelines carrying natural and/or methane gas, oil, gasoline, diesel fuel, in chemical plants etc. The ability to reduce and or eliminate static electricity reduces the opportunity of an explosion as when the static charge comes into contact with a gas pocket.

The present pipeline filter also has a support for retaining a screen filter such as a cone strainer with its primary function to trap large particles of metal and other foreign contaminants. However, the screen filter can be removed from the pipeline filter, if the screen filtering is no longer desired, or if it is desired to replace the screen filter with one having different qualities such as different size exclusion (and therefore less resistance to pipeline fluid flow). If the screen filter is removed, the remaining structure of the pipeline filter can be placed into the pipe system to continue collecting the ferrous metal contamination with little flow resistance to the fluid passing through.

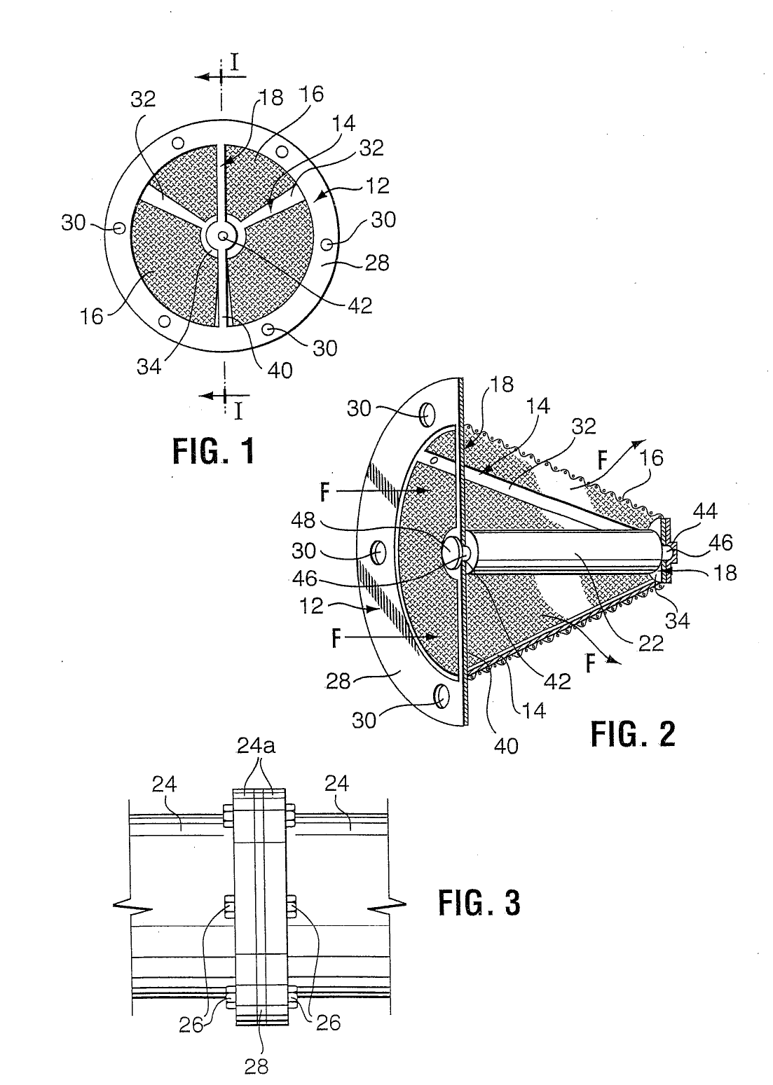

With reference to FIG. 1, a pipeline filter is shown according to one aspect of the present invention. The pipeline filter may include a pipeline mounting structure 12 for mounting the filter in a pipe line, a screen support 14 connected to the mounting structure and formed for releasably securing a screen filter 16 to the pipeline filter and a magnetic filter support 18 through which a magnetic filtering device 22 may be secured to the mounting structure.

When fully assembled and ready for use to filter fluids passing through a pipeline, at least one of screen filter 16 and magnetic filtering device 22 are installed in filter 10 to act on the fluids passing through the pipeline.

Pipeline mounting structure 12 may take various forms. In the illustrated embodiment, structure 12 includes a flange fitting insert for installing the filter in a pipeline flange connection. For example, with reference to FIG. 3, a pipeline flange connection includes at least two pipe forms 24 with flange-formed ends 24a each with a plurality of apertures therethrough for accepting installation of bolts 26 or other fasteners therein. A flange fitting insert for a pipeline filter may include an annular plate 28 for installation between flange formed ends 24a of the pipe forms and a plurality of apertures 30 through the annular plate for accepting the bolts therethrough. The apertures 30 can be positioned with consideration as to the placement of apertures through the pipe flange-formed ends 24a.

Of course, other mounting structures can be used such as unapertured flanges for catching on a shoulder in a pipeline inner bore, tabs, biasing members, brackets, stands, legs, etc., as desired and/or with consideration as to the form and configuration of the pipeline into which the filter is to be installed.

Screen support 14 is connected to the mounting portion and formed for releasably securing a screen filter. Since the structure of screen support 14 may be positioned in the inner diameter of the pipeline and may therefore resist the flow of fluid, arrows F, through the pipeline, the screen support may be formed to occupy a minimum space in the inner diameter of the pipeline. However, since screen support 14 holds the screen filter in the flow of fluid, it must be rugged and able to resist breakdown in the fluid flow. In the illustrated embodiment, screen support 14 is formed as a conical support frame for securing a cone-type filter screen. The screen support may be formed to support the screen against its upstream or downstream sides. However, it will be appreciated that an arrangement that supports the screen against the upstream side of the support provides that any fluid force against the screen forces the screen against the screen support. Screen support 14 includes a plurality of spaced apart ribs 32 connected, as by welding or forming, at one end to mounting structure 12. From the mounting structure, ribs 32 extend in a direction out of the plane of the structure and converge toward a base structure 34. Openings are formed between the ribs through which the pipeline fluids may flow.

Screen filter 16 may be secured on the screen support in various ways. In one embodiment, the screen filter may be releasably secured on the screen support to permit the screen filter to be removed for use of the pipeline filter without a screen and for cleaning and replacement of the filter as desired. Releasable attachment may be achieved in various ways, as by use of fasteners, welds, rivets, clips, pins, wire ties, brackets, etc. While some connections such as welds and rivets may require extra effort for removal, such as by grinding, breaking, cutting, etc., such connections provide that there are no parts that can easily come loose during use and become entrained in the fluid flow. As such, it may be desirable to connect screen filter 16 to its support using a connection that requires physical destruction to remove same such as rivets or welds. Using such connections, it may be useful to connect the screen filter to the screen support in a limited number of locations such as fewer than five places. For example, one spot weld or rivet per rib 32 located adjacent mounting structure 12.

Screen filter 16 may take various forms. For example, the screen filter may have various shapes, be formed of various materials (i.e. metals, polymers, fibrous materials, etc.) and using various construction methods and may have various sizes of apertures. The selection of these parameters may depend on cost, convenience, the nature of the fluid and pipeline in which the filter is to be used and the size of debris to be filtered. In one embodiment, the screen filter may be formed of stainless steel, which enhances its usefulness in corrosive/reactive environments and may enhance its durability and reusability. The screen filter may be formed of mesh material, apertured sheet materials, etc. The screen filter may be a single layer of material or multi-layered such as including a support layer such as a large apertured sheet and a fine filtering layer.

Magnetic filter support 18 may be formed to permanently or releasably secure a magnetic filtering device. Magnetic filter support 18 may be secured, as by for example welding or forming, to mounting portion 12 such that magnetic filtering device 22 is held in the pipeline in the flow of fluids therepast. Support 18 may include, for example, cross members, apertured plates, retainers, frames, etc. to hold the magnetic filter substantially centrally in the pipeline flow such that the magnetic field generated thereby acts on a large volume of fluid passing thereby and therearound. Support 18 can be formed to permanently or releasably secure device 22. Since device 22 is reusable simply by cleaning attracted debris therefrom, this can be done while the device is secured in the mounting structure. However, to facilitate cleaning, replacement, etc. the support can be formed to allow for removal of device 22, as desired.

In the illustrated embodiment, support 18 includes a cross member 40 extending across and adjacent screen support 14 and including an aperture 42 for accepting an end of magnetic filtering device 22. Aperture 42 is positioned generally centrally relative to annular plate 28 such that when the plate is installed in a pipeline, the aperture 42 is positioned to hold device 22 generally centrally in the pipeline inner diameter. In the illustrated embodiment, support 18 further includes a retainer 44 spaced from cross member 40 to hold another portion of device 22 such that it is held securely in the flow. Retainer 44, in this embodiment, includes an opening for engaging an end of device 22, for example, an opening sized to accept an end of the device. Retainer 44 is shown as a portion of base structure 34. Of course, the selected form of support 18 will depend on the form of the magnetic filtering device intended to be installed therein.

Magnetic filter support 18 is positioned adjacent and may be upstream or downstream of the screen support. In one embodiment, magnetic filter support 18 may be positioned to retain device 22 on an upstream side of the screen support, and in particular, of screen 16. With such a placement, device 22 can collect debris attracted thereby from the fluid flow prior to the flow reaching the screen. This may reduce flow restrictions created by the pipeline, increase the useful life of the screen and reduce the need for cleaning, by collecting materials on device 22 which would otherwise be collected on screen filter 16 leading to clogging thereof.

Magnetic filtering device 22 may take various forms. For example, device may have various shapes, be formed of various materials (i.e. metals, polymers, fibrous materials, etc.) and using various construction methods and may have various magnetic powers. The selection of these parameters may depend on cost, convenience, the nature of the fluid and pipeline in which the device is to be used and the volume of flow to be filtered. In one embodiment, device 22 may include a housing of stainless steel, which enhances its usefulness in corrosive/reactive environments and may enhance its durability and reusability. In order to provide a large surface area, as illustrated, device may include a rod form housing with magnets positioned therewithin along its length. Support 18 can be formed to retain the rod with its long axis substantially parallel and possibly coincident with the long center axis of the pipeline. Where the screen is formed as a cone, support 18 may be formed to retain the rod-form magnetic filter to extend into the inner diameter defined within the cone. For example, support 18 may include a first mounting structure, such as cross member 40, extending across the larger diameter open end of the cone and a second mounting structure, such as retainer 44, adjacent the apex of the conical screen.

In the illustrated embodiment, rod-form device 22 includes mounting posts 46 extending at each end and mounting structure 18 is formed to act on the posts. For example, aperture 42 removably accepts one post 46 therethough and such post is secured therein by a threaded fastener 48, rivet, weld, pin, plastic deformation, etc. and retainer 44 is formed as a cup into which opposite post 46 may be inserted and held. Device 22 may be installed by inserting one post first into its mounting structure and manipulating the device and/or the mounting structures to allow the other post to be placed into its mounting structure. If fasteners are used that have separable parts, extra caution may be used to avoid the loss of such parts in fluid flow if they become separated.

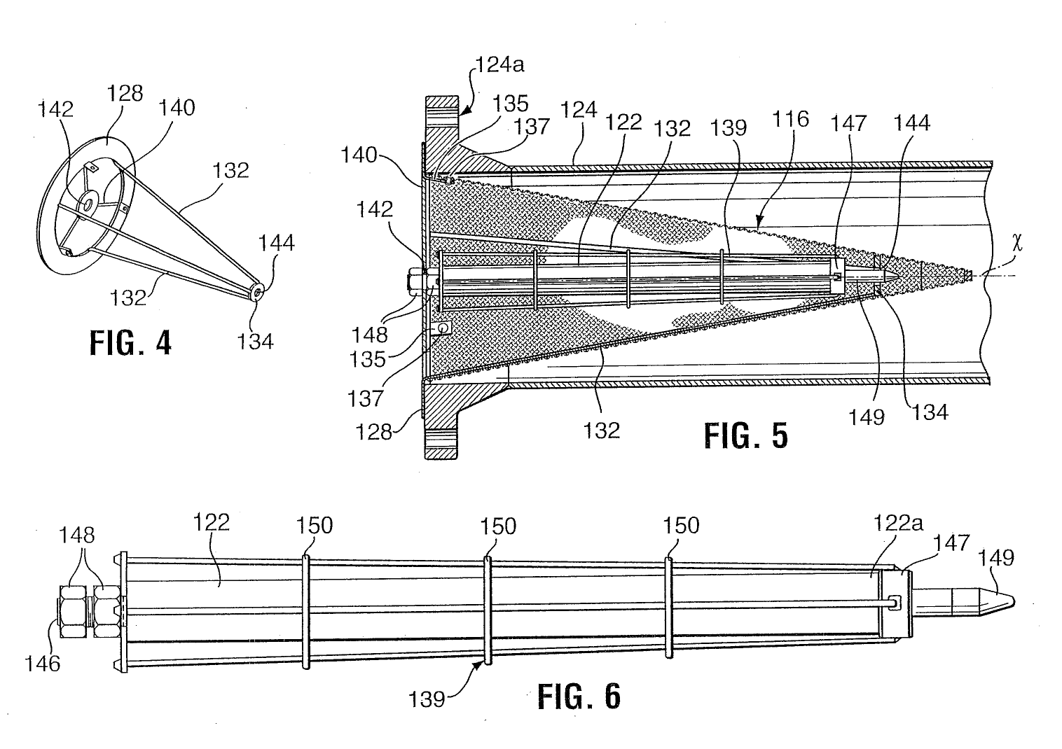

With reference to FIG. 4, a pipeline filter is shown according to another aspect of the present invention. The pipeline filter may include a pipeline mounting structure for mounting the filter in a pipe line, a screen support connected to the mounting structure and formed for releasably securing a screen filter to the pipeline filter and a magnetic filter support through which a magnetic filtering device may be secured to the mounting structure.

As shown in FIG. 5, when fully assembled and ready for use to filter fluids passing through a pipeline 124 at least one of screen filter 116 and magnetic filtering device 122 are installed in the filter to act on the fluids passing through the pipeline.

As noted previously, the various parts of the pipeline filter may take various forms and the following describes only that example of FIGS. 4 and 5.

In the illustrated embodiment, the pipeline mounting structure includes a flange fitting insert for installing the filter in a pipeline flanged connection. For example, the mounting structure includes an annular planar flange 128 for installation between flange formed ends 124a of the pipeline pipes.

The screen support is connected to the mounting portion and formed for releasably securing a screen filter. In the illustrated embodiment, the screen support is formed as a conical support frame for securing a cone-type filter screen and includes a plurality of spaced apart ribs 132 connected, as by welding or forming, at one end to flange 128. From the mounting structure, ribs 132 extend in a direction out of the plane of the flange and converge toward a base structure 134. Large opening spaces remain between the ribs through which the pipeline fluids may flow.

In the illustrated embodiment, the screen support further includes a plurality of tabs 135 extending from flange 128 through which connectors such as rivets 137 may be passed to secure the filter 116 to the tabs. To remove screen filter 116 from the screen support, the rivets may be broken off or ground down. Such removal allows the pipeline filter to be used without the screen filter and/or allows the screen to be replaced with another screen filter or after cleaning.

Screen filter 116 includes a perforated conical form over which is secured a finer filtering media such as of stainless steel mesh. The apertures through the finer filtering media provide size exclusion that separates debris from the fluid flow passing therethrough. As such, the filtering effect of the screen filter may be selected by selecting the aperture size of the filtering media. The perforated conical form protects and provides support for the filtering media.

In the illustrated embodiment, magnetic filter support includes a cross member 140 extending across the open large diameter end of the conical form created by ribs 132. Cross member 140 includes an aperture 142 for accepting an end of magnetic filtering device 22. Aperture 142 is positioned generally centrally relative to annular flange 128 such that when the pipeline filter is installed by flange in a pipeline, the aperture 142 is positioned to hold device 122 generally centrally in the pipeline inner diameter. In the illustrated embodiment, a retainer aperture 144 spaced from cross member 140, and in particular formed through base 134, holds an opposite end of device 122. Apertures 142, 144 are formed to retain the magnetic filtering device with its long axis substantially parallel and possibly coincident with the long center axis x of the pipeline and with device extending into the inner diameter defined within the conical form of screen filter 116.

With reference also to FIG. 6, device 122 is installed as part of an assembly including an installation frame 139 about the device. In the assembly, device 122 generates a magnetic field that attracts and retains ferrous particles and may neutralize statically charged particles. In the illustrated embodiment, device an elongate tubular housing of stainless steel filled with magnets. In one particular embodiment, a device may be used that includes a plurality of magnets separated by non-magnetic spacers that concentrate and increase the outward effect of the magnetic field generated by the magnets. For example, the device may include a plurality of magnets that generate magnetic fields over approximately 40 to 60% of the length of the housing and having a diameter at least five times the diameter of the housing. Reference may be made to applicant's U.S. Pat. No. 6,706,178, issued Mar. 16, 2004 and applicant's International application filed concurrently herewith, incorporated herein by reference.

In the illustrated embodiment, device 122 includes a threaded mounting post 146 at one end for passing through aperture 142 and securing to cross member 140 by bolts 148. Installation frame 139 includes a base 147 carrying a mounting pin 149 that extends at an end opposite that end from which post 146 extends, when device 122 is installed in the frame. Frame 139 further includes a centralizing pin (cannot be seen) on base 147, that may be inserted in an indentation in end 122a of the device to hold it in a selected position within the frame.

Frame 139 may take various forms, as desired, and serves various purposes. Frame 139 may provide a safe spacing about the magnetic filtering device to prevent the device from becoming problematically attracted to ferrous surfaces during handling. In one embodiment, frame 139 can accept a number of different forms of magnetic filtering devices, while offering a uniform installation to the pipeline filter. Also, frame 139 can include laterally extending protrusions 150 that create turbulent flow along the sides of the magnetic filtering device, thereby enhancing the volume of fluid through the magnetic field generated by device 122.

To facilitate installation of frame 139 in the pipeline filter, the length between the outboard end of post 146 and the end of base 147 can be selected to be less than the distance between apertures 142 and 144 and the distance between the outboard end of post 146 and the outboard end of pin 149 can be selected to be more than the distance between apertures 142 and 144. Also or alternately, pin 149 can include a chamfered tip to facilitate insertion into its mounting aperture. For example, frame 139 with device 122 therein may be installed by inserting pin 149 first through aperture 144 until base 147 butts against base 134. At this point, post 146 can be moved into alignment with aperture 142 and the frame can be moved to drive the post through aperture 142. The uppermost of bolts 148 can then be threaded onto the post to hold the post in its aperture. At the same time pin 149 stays positioned in aperture 144 simply due to the length of the parts.

Frame 139 may be formed of materials that are not magnetically attracted to the device. Device 122 can be removable from frame 139 for cleaning, etc. Device 122 can be cleaned by sliding debris along the surface of the housing to a non-magnetic end such as end 122a.

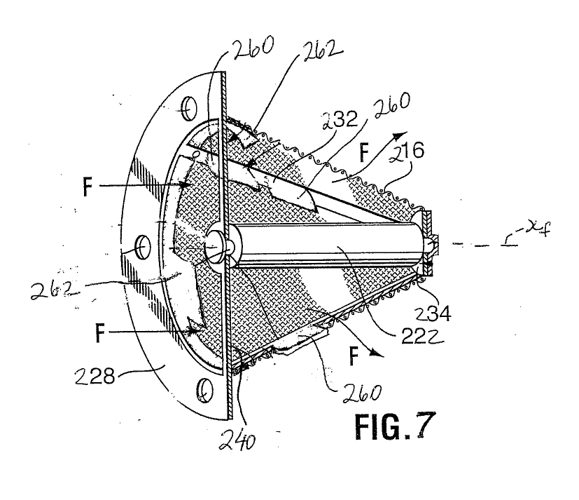

Any magnetic filtering device, such as device 22 or device 122 of the aforementioned figures and description, acts by attracting metal materials passing through the magnetic field generated by the device. As such the size of the device's magnetic field determines the affected volume of the pipeline fluids that will be treated by use of the device. If the magnetic field does not have a diameter equal to or larger than the diameter of the pipe in which it is installed, fluid may pass through the pipeline filter without actually being treated by the device's magnetic field. As such, and with reference to FIG. 7, in one embodiment, the pipeline filter may include one or more structures 260, 262 to generate turbulence in the fluid passing thereby, which structures are positionable upstream of at least a portion of the magnetic filtering device, with consideration as to the intended configuration of the filter during use. Such structures 260, 262 may be selected to disrupt laminar flow of the fluid such that the fluid will be diverted to pass at least for a short residence time through the magnetic field generated by the device. In one embodiment, the one or more structures may be selected to create eddies or vortexes in the fluid flow. Of course, many structures can be formed to disrupt laminar flow. For example, cross members 240 may be formed in any of various ways to disrupt laminar flow to create turbulence in the fluid flow. In one embodiment, however, flow diverting structures may be provided on the pipeline filter such as structures 260 carried on ribs 232 each formed as a vane to generate a vortex in fluid passing thereover. While structures 260 are installed on the filter support, additionally or alternately, structures for diverting flow can be installed on the filter 216. For example, structure 262, formed as a vane, can be installed on the screen filter to act on fluid flow passing thereover.

Structures 260, 262 may include a surface that is inclined out of line with the installed long axis of the filter, for example which would normally be the orthogonal axis xf through the plane of mounting flange 228. The surface may be planar or curved and is selected to direct the flow of fluid to be disrupted out of laminar flow, such as to form an eddy or vortex. As such, fluid that originally is passing along the wall of the pipe that is acted upon by the structure would be diverted from its current path and may be driven inwardly into the magnetic field of the magnetic filtering device, whereas the fluid may not have passed through or had sufficient residence time in the magnetic field.

The surface may be oriented to direct the fluid along a selected path or, with consideration as to the fluid in which the pipeline filter is to act, to set up a particularly selected turbulent condition.

Flow diverting structures may be formed on the above-noted parts and/or other parts such as on one or more of the cross members 240, base 234 or mounting flange 228. In the illustrated embodiment, the filter shown is intended to be placed in a pipeline to treat flow passing from the flange toward the base. Since filters according to the present invention can be used to treat flows passing in either direction therethrough, it is noted that the vanes can be formed and positioned to act on flow in either direction. For example, in some embodiments, one or more vanes may be formed on base 234 or ribs 232 on a side thereof facing away from flange 228.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A pipeline filter comprising: a pipeline mounting structure for mounting the pipeline filter in a pipeline, a screen support connected to the mounting structure and formed for releasably securing a screen filter to the pipeline filter and a magnetic filter support through which a magnetic filtering device is securable to the mounting structure.

2. The pipeline filter of claim 1 wherein the pipeline mounting structure includes a flange fitting insert for installing the pipeline filter in a pipeline flange connection.

3. The pipeline filter of claim 2 wherein the flange fitting includes an annular plate and a plurality of apertures passing through the annular plate.

4. The pipeline filter of claim 1 wherein the screen support includes a plurality of ribs forming a conical structure and openings created between the plurality of ribs.

5. The pipeline filter of claim 1 wherein the magnetic filter support includes a retainer to position the magnetic filtering structure substantially centrally relative to the pipeline mounting structure.

6. The pipeline filter of claim 1 wherein the magnetic filter support includes a cross member extending across and adjacent the screen support and including an aperture for accepting an end of the magnetic filtering device and a retainer spaced from the aperture for accepting an opposite end of the magnetic filtering device.

7. The pipeline filter of claim 1 further comprising a vane to cause disruption of fluid flow over passing through the filter.

8. The pipeline filter of claim 1 wherein the screen support is formed as a cone and the magnetic filter support is formed to retain the magnetic filtering device extending into the inner diameter defined within the cone.

9. The pipeline filter of claim 1 wherein the magnetic filter support includes a first mounting structure extending across the cone's larger diameter open end and a second mounting structure adjacent the cone's apex.

10. A pipeline filter comprising: a pipeline mounting structure for mounting the pipeline filter in a pipeline; a screen support connected to the mounting structure; a screen filter releasably secured to the screen support; a magnetic filter support; and a magnetic filtering device secured to the mounting structure.

11. The pipeline filter of claim 10 wherein the pipeline mounting structure includes a flange fitting insert for installing the pipeline filter in a pipeline flange connection.

12. The pipeline filter of claim 11 wherein the flange fitting includes an annular plate and a plurality of apertures passing through the annular plate.

13. The pipeline filter of claim 10 wherein the screen support includes a plurality of ribs forming a conical structure and openings created between the plurality of ribs.

14. The pipeline filter of claim 10 wherein the screen filter is releasably connected to the screen support using a connection that requires physical destruction to be removed.

15. The pipeline filter of claim 10 wherein screen filter is formed as a cone.

16. The pipeline filter of claim 10 wherein the magnetic filter support includes a retainer to position the magnetic filtering structure substantially centrally relative to the pipeline mounting structure.

17. The pipeline filter of claim 10 wherein the magnetic filter support includes a cross member extending across and adjacent the screen support and including an aperture for accepting an end of the magnetic filtering device and a retainer spaced from the aperture for accepting an opposite end of the magnetic filtering device.

18. The pipeline filter of claim 10 further comprising a vane carried thereon to create turbulence of fluid flow over passing through the filter.

19. The pipeline filter of claim 10 wherein the magnetic filtering device includes a rod-form housing and magnets positioned therewithin along the length of the rod-form housing.

20. The pipeline filter of claim 10 wherein the magnetic filtering device is supported within a frame and the frame is secured at least in part to the magnetic filter support.

21. The pipeline filter of claim 10 wherein the screen support is formed as a cone and the magnetic filter support is formed to retain the magnetic filtering device extending into the inner diameter defined within the cone.

22. The pipeline filter of claim 21 wherein the magnetic filter support includes a first mounting structure extending across the cone's larger diameter open end and a second mounting structure adjacent the cone's apex.

23. A method for filtering fluids flowing in a pipeline comprising: installing in the pipeline a pipeline filter including a magnetic filtering device and a screen filtering device secured adjacent to the magnetic filtering device; and allowing the fluids to pass through a magnetic field generated by the magnetic filtering device and thereafter allowing the fluids to pass through the screen filtering device.

24. The method for filtering fluids of claim 23 further comprising removing the pipeline filter from the pipeline; removing the screen filtering device; and reinstalling the pipeline filter to place the magnetic filtering device in the fluids.

25. The method for filtering fluids of claim 23 further comprising removing the pipeline filter from the pipeline; cleaning the screen filtering device and the magnetic filtering device; and reinstalling the pipeline filter into the pipeline.

26. The method for filtering fluids of claim 23 further comprising removing the pipeline filter from the pipeline; replacing the screen filtering device with a second screen filtering device of different size exclusion; and reinstalling the pipeline filter into the pipeline.

27. The method for filtering fluids of claim 23 wherein the fluids after passing through the pipeline filter include reduced quantities of ferrous contaminants and reduced amounts of static electricity.
